(19) United States
(12) Patent Application Publication
(10) Pub. No.: US 2015/0061258 A1
(43) Pub. Date: Mar. 5, 2015

(54) Wheelchair lighting system

(71) Applicants: Robert Flores, St. Charles, MO (US); Michael Cravens, St. Peters, MO (US)

(72) Inventors: Robert Flores, St. Charles, MO (US); Michael Cravens, St. Peters, MO (US)

(21) Appl. No.: 14/121,227

(22) Filed: Aug. 12, 2014

Related U.S. Application Data
(60) Provisional application No. 61/959,601, filed on Aug. 28, 2013.

(51) Int. Cl. A61G 5/10; F21V 21/096; F21V 33/00

(52) U.S. Cl. CPC A61G 5/10; F21V 33/0068; F21V 21/0965
USPC 280/304.1; 29/428; 29/700

(57) ABSTRACT

Modifications to an armrest for a wheelchair include the application of a double sided tape, cut to dimensions that fits conveniently onto the undersurface of the armrest for the wheelchair, and which double sided tape has adhered thereto a corresponding metal strip, that provides a permanent metal surface to the underside of the armrest, for application and adherence of a flashlight magnet for holding the flashlight in position during movement by the person using the wheelchair. The light may be directed forwardly, rearwardly, or removed for directing its illumination in different directions.

### CROSS REFERENCE TO RELATED APPLICATION

This non-provisional patent application claims priority to the provisional patent application having Ser. No. 61/959,601, filed on Aug. 28, 2013.

### FIELD OF THE INVENTION

This invention relates generally to lighting facilities, and more specifically pertains to the adaptation of a wheelchair, and particularly the armrest of a wheelchair, for accommodating a lighting system to facilitate illumination forwardly and/or rearwardly of the wheelchair during its usage, particularly in darkened areas.

### BACKGROUND OF THE INVENTION

Obviously, wheelchairs, being fully equipped with armrests and other integrated accessories, have long been available in the art. Some of them may include and use lighting systems in their integrated structure in order to aid the users thereof in their operation of the wheelchair. However, many wheelchairs do not include lighting systems or the electrical power sources that are required for the operation of a wheelchair lighting system.

There have also been available in the art lighting systems that can be added to wheelchairs. Typically, these types of add-on systems include lights that are intended to be permanently secured to the wheelchair and which cannot be readily removed by a user during use of the wheelchair and which cannot be readily and conveniently re-oriented to point in a different direction, as may be done with the current invention. Typically, such add-on systems also include, or require the addition of, some kind of electrical power source to the wheelchair for providing power for the lighting system.

In general, such lighting systems, whether integrated with the chair or add on systems, are relatively large and cumbersome. Many wheelchairs with such systems are not intended to be readily portable or foldable, and/or the size and location of the components of such lighting systems on the wheelchairs make folding and portability impractical. Because of such limitations, users of such types of wheelchairs may also still require portable and foldable wheelchairs under various circumstances.

Users of wheelchairs without lighting systems, especially wheelchairs that are intended to be portable and foldable, often may have to use their wheelchairs in darkened areas. Because of the lack of available light, navigation is more difficult than is desirable.

Because of such difficulty, some users try to use a flashlight held in one of their hands or resting in their laps to direct light forwardly as they try to operate the wheelchair. Both actions present a user with difficulties in that he/she must either try to operate the wheelchair while holding the flashlight in one hand or while hoping the flashlight will remain in place on his/her lap while operating the wheelchair.

Various types of flashlights have been readily available in the art, including some that incorporate magnets therewith. Flashlights with associated magnets are useful for accommodating the storage of such flashlights while magnetically coupled with the metallic surface of some device, such as the door or side of a refrigerator when the flashlight is in use. A variety of flashlights with associated magnets, often of somewhat larger sizes to accommodate C size batteries, have been available in the art.

In general, there has been no readily available and convenient way to easily and effectively accommodate the temporary attachment and removal of a lighting source, such as a flashlight, especially a smaller sized flashlight, such as a pen light, to a wheelchair for use as a source of temporary lighting, including because most wheelchairs are designed to make maximal use of lighter weight materials, including aluminum instead of other ferrous metals. Consequently, most wheelchairs do not provide appropriate surfaces to which a flashlight, even a flashlight with an associated magnet can be conveniently attached to the wheelchair to act as a wheelchair light. Moreover, attempts at other types of attachment, such as by trying to tape or clamp flashlights to portions of the wheelchair, have typically proved unreliable and unsatisfactory, and the flashlights so taped or clamped have generally been unstable and generally ineffective in providing the desired lighting, have often interfered with foldability and/or portability of the chairs, have typically been a source of interference with external doorways and objects, and have been a frustration for users.

Consequently, providing light to assist a user of a wheelchair under darkened conditions has remained a problem.

### SUMMARY OF THE INVENTION

The concept of the current invention is to provide an adaptation to the armrest of a wheelchair, especially a foldable wheelchair, so that a lighting system, such as a flashlight associated with a fastening magnet, can be easily, yet readily removably, attached to the wheelchair so as to furnish ready lighting for an invalid in the wheelchair, particularly when he/she is using the wheelchair to move about, and/or to provide a portable light, such as a flashlight, that may be readily removed and applied by the invalid when he/she desires to use the flashlight for other purposes.

Generally, the underside of the armrest needs adaptations to provide for the accommodation of a flashlight. Such adaptations, which may be provided in the form of a kit, may preferably include the application of a double sided tape to the undersurface of the armrest, on either side, of the wheelchair, and application of a metallic strip, of corresponding size to the tape, to provide for a metallized undersurface to the armrest for further usage. Then, a flashlight that has a magnet rigidly fastened to the surface of its cylinder can be readily applied to the metallic strip on the underside of the armrest of the wheelchair, and the flashlight light can generally be directed forwardly to provide ready lighting in front of the wheelchair during usage thereof. Optionally, another flashlight may be applied under the armrest on the other side of the wheelchair, and that light may be directed forwardly, or even rearwardly, to provide peripheral lighting for the user of the wheelchair as the wheelchair is moved through a rather darkened area. When a user requires nighttime usage of the chair, a light can thus be readily attached onto the armrest as a welcomed improvement that aids the user in movement through darkened areas.

It is, therefore, the principal object of this invention to provide a lighting system that will be able to furnish ambient lighting around a wheelchair during its usage.

Another object of this invention is to provide lighting that may be readily directed forwardly, or rearwardly, as required, which lighting can be easily affected through the use of a portable flashlight that can adhere to the armrest of a wheelchair during its application and usage.

Still another object of this invention is to provide a kit, such as of tape and a metallic surface securable thereto, that can be applied to an armrest for a wheelchair, and which can accommodate the attachment of a lighting assembly thereto for use when the wheelchair is traversing through darkened areas.

Yet another object of this invention is to provide a mounted light on a wheelchair, which light may be readily removed for independent usage. Preferably, the mounted light, before being applied to the wheelchair to function as a form of headlight, will have had the general form of a flashlight, particularly a flashlight of a small or penlight size, so that it may thereafter be easily detachably removed from the wheelchair for convenient independent usage by a user as a flashlight.

A further object of this invention is to allow a design for lighting of a wheelchair that provides for ease of usage, and does not interfere with the wheelchair when it is folded for transporting.

A further object of this invention is to provide a lighting system for a wheelchair that is safe to install and operate, and does not interfere with the person negotiating the wheelchair. It can also be left in place when not in use.

Another object of this invention is to provide a flashlight like device that has its on-off switch readily disposed for operation by the wheelchair occupant.

These and other objects may become more apparent to those skilled in the art upon review of the summary of the invention provided herein, and upon undertaking a study of the description of its preferred embodiment, in view of the drawings.

### BRIEF DESCRIPTION OF THE DRAWINGS

In referring to the drawings:

FIG. 1 provides an exploded front view of a padded armrest for a wheelchair, showing the manner in which the armrest is held and integrated into the wheelchair structure through its support, and disclosing elements of a preferred construction that are used for attaching and holding a magnetic flashlight to the armrest for use as a mounted wheelchair light during application and usage of the wheelchair;

FIG. 2 provides a plan view of a metal strip sized and configured to be secured to the underside of the armrest of FIG. 1; and

FIG. 3 provides a side view of the padded armrest of FIG. 1, a double sided tape that may be applied thereunder, and a length of galvanized metal strip of corresponding dimensions that may be applied to the underside of the armrest and held in position by means of the double sided tape, and for use for application of the magnet of a battery operated lighting system thereto during usage.

### DESCRIPTION OF THE PREFERRED EMBODIMENT

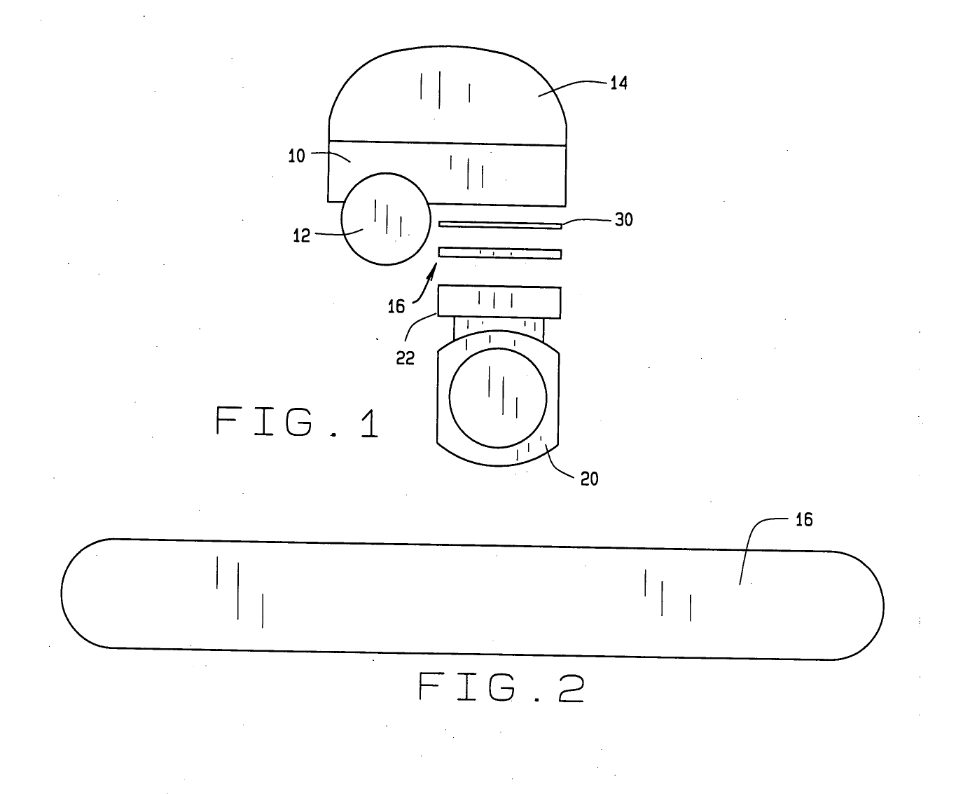

In referring to the drawings, FIG. 1 discloses, in an exploded view, the concept of this invention as included in a preferred embodiment. Generally, FIG. 1 shows an armrest 10 of a wheelchair, which armrest 10 is supported on the wheelchair by means of a support 12 and has a padded arm support 14 applied to the topside of the armrest 10. A mounting component 16 is shown positioned beneath the armrest 10 for attachment to the underside area generally underneath of the armrest, such as the surface 18, to facilitate the placement and attachment of a flashlight 20, with an integrated magnet 22, to the armrest 10 along the underside of such armrest 10.

Attachment of the mounting component 16 to the underside surface 18 of the armrest 10 is facilitated by application of a double sided tape 30 having tacky surfaces both upon its upper and lower surfaces and adherence of the upper side of such tape 30 to that underside surface 18 of the wheelchair armrest 10. Such tape 30 is preferably cut to size to provide for its convenient fit to the surface 18 on the underside of the armrest 10, as can be understood.

The mounting component 16 is then secured to the lower side of such double sided tape 30, as can be noted. Such mounting component 16, such as a relatively thin galvanized metal plate or strip, preferably having corresponding dimensions to the size and shape of the double sided tape 30, is applied to the lower side of the tape 30 to provide a secured metallic surface against and to which the flashlight magnet 22 may be adhered, and through which the flashlight 20 may be held in position during usage.

Removable attachment of the flashlight 20 to the armrest 10 is effected through the use of the magnet 22 integrated with the flashlight 20, with the magnet 22 being placed against the metallic strip 16 to effect a coupling attachment of the flashlight 20 thereto. The attached flashlight is operable to furnish lighting within the immediate area, either forwardly, or rearwardly, as required by a user while motivating within the associated wheelchair.

Generally, the battery operated light, or flashlight like device, should be long enough to allow its magnet 22 to be approximately 2-3 inches back from the LED light provided in its front. This will allow the user to slide the light forward, and also allow the LED light to clear the framework of the wheelchair during usage. In doing so, it allows a full spectrum of light to be projected forwardly. When not in use, the light can be anywhere along its metal plate 16, so as to place it in an unobstructing location, during nonusage.

Obviously, just as useful may be the removal of the flashlight 20, with its integrated magnet 22, from the metallic strip 16 when the user desires to have ready application of a flashlight, for use for flashing in other directions when that becomes necessary or desirable.

FIG. 2 shows a plan view of a metallic strip 16 sized and configured to conveniently fit beneath the armrest 10 of a typical wheelchair.

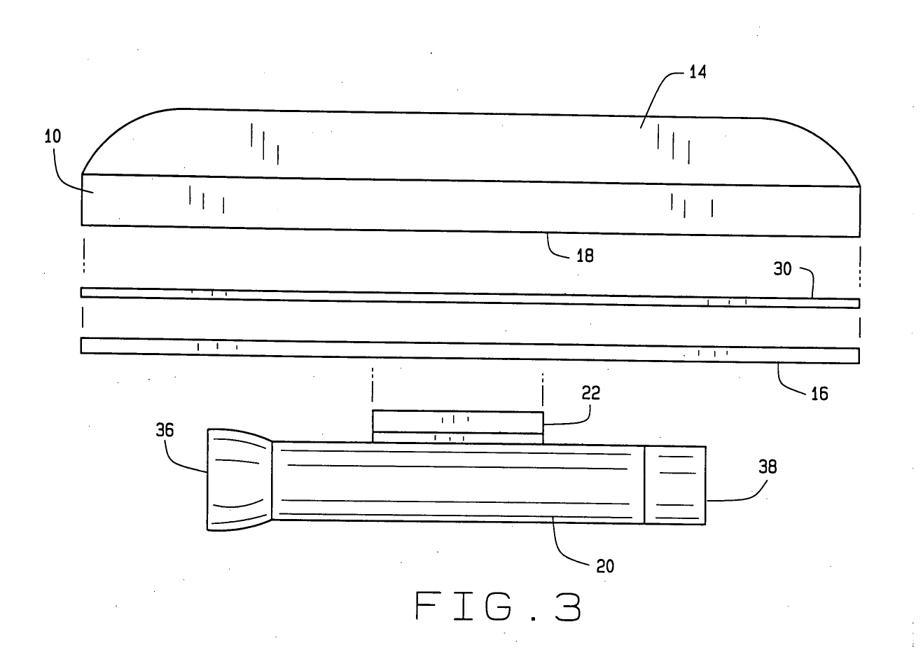

FIG. 3 shows a side view of the padded armrest 10 and its undersurface 18, as can be noted. The double sided tape 30, which is preferably of industrial strength, is preferably of such a strength that once it is applied to the undersurface 18 of the armrest 10 it will be adhered in place permanently, particularly since a flashlight 20 may be applied to the metallic strip 16, or removed, many times without disrupting the adherence of upper surface of the tape 30 to the undersurface of the armrest and/or the adherence of the lower surface of the tape 30 to the metallic strip 16.

For much the same reason, the metal strip 16 is preferably a galvanized metal strip of a 26 gauge, more or less, and is generally cut to the same dimensions as the double sided tape so that it will fully cover the tacky lower surface of the tape 30. This has generally been found adequate to hold the metal strip 16 in position, once again, for repeat applications of a flashlight thereto during usage of the wheelchair lighting system.

The flashlight 20 is depicted in FIGS. 1 and 3 with the magnet 22 rigidly secured thereto, such as by rivets or by other suitable connection devices and/or techniques between these two components. As noted in FIG. 3, the flashlight 20 preferably has a frontal light, as noted at 36, and may also have a rear directed light 38, where such may be desirable.

In any event, a goal of this invention is to enhance and improve the mobility of individuals using wheelchairs, especially portable or foldable wheelchairs, including by the provision of a portable light device that can be conveniently mounted upon the wheelchair to provide lighting assistance to the wheelchair user as he/she attempts to move about in the wheelchair, particularly in darker areas, and by allowing the user to readily and conveniently remove such mounted light device and use it as a flashlight when circumstances make it so desirable. Preferably, the light device is in the form of a flashlight that may illuminate both forwardly, and perhaps rearwardly, which is held in a relatively stable position on the underside of an armrest of the wheelchair when mounted thereto, such as by means of a magnet integrated therewith, so as to direct light towards that area where the user needs to move when using the wheelchair. With such a light device, the flashlight 20 may thereafter be readily removed from the wheelchair by separating its magnet 22 from the metal strip 16 so that the flashlight can then be held by the user and directed in other orientations to light a desired area when the user has arrived at his/her desired location.

It may be a potential modification to this invention, by way of example, that the mounting component 16 applied to the undersurface of the double sided tape may be a magnetic strip of metal or magnetized doped polymer so as to function as a magnet, and to which a metallic body or portion of an independent flashlight may be coupled for temporary connection in order to furnish illumination in various directions during usage of the wheelchair. In other words, the magnet may be included as the, or a portion of the, mounting component secured to the wheelchair rather than as part of the lighting device intended for mounting upon the wheelchair. Such a configuration offers a further advantage in that a user could then readily attach other metallic objects and accessories, such as scissors, to the magnet, in addition to or instead of the flashlight, to more easily transport such accessories from place to place.

The various mounting components 16 intended to be applied to the wheelchair may be secured thereto under either of the wheelchair armrests or even under both of the right and left armrests if it is desired to furnish lighting on both sides of the wheelchair. Hence, the preferred metal strips 16, and the double sided tape 30 employed for securing such metals strips, will typically be of identical design so as to be interchangeable between the right and left side armrests for the chair. As has already been explained, such metal strips are typically intended to be permanently attached to the underside of the armrest with the double sided tape, which may be applied to both armrests so as to furnish readily available surfaces to which a magnetic flashlight may be adhered during usage.

While it is envisioned that a kit for use in installing a removable light beneath the armrest of a wheelchair will typically include double sided tape for use in securing a mounting component to the wheelchair, it is recognized that the inclusion and use of double sided tape is not mandatory and that other constructions, devices, and techniques may also be utilized for securing a metal strip, or a component including a magnet portion, to the armrest of a wheelchair.

It is also recognized that, while the use of magnetic coupling permits ready binding or coupling of a flashlight to the armrest of a wheelchair, as has been explained hereinabove, other techniques and manners of temporarily attaching the flashlight to the wheelchair could also be readily employed to achieve the same or like effect. For example, and not by way of limitation, the flashlight and a mounting component secured to the wheelchair could employ complementary hook and loop connection systems, such a Velcro® fasteners, that would permit the easy attachment and removal of a flashlight from the wheelchair.

As noted hereinabove, the lighting system may be a dual lighting system with each light system being independent of the other. In such event, the light systems are preferably intended to be identical in their designs and interchangeable. They can be used either on the right or the left side armrest, or on both, and directed either forwardly or rearwardly, as desired.

Preferably, the light systems will be battery operated flashlights, typically of smaller sizes, such as of penlight size to accommodate A or AA or smaller, such as coin sized, batteries, and to be readily held and manipulated by a wheelchair user, and generally will have a front directed lighting system, but a rear light may also be available upon such a flashlight. The flashlights of the preferred embodiments discussed hereinabove include permanent magnets secured and attached thereto, which allows for easy attachment of the flashlights to the armrest and their easy removal for use as a handheld flashlight and for ease of battery changing.

If desired, the flashlights may be designed to include circuitry or other construction to permit the recharging of the batteries or like power sources for the flashlights, and, if the wheelchair includes an electric power source, the flashlights may be connectable to the electric power source of the wheelchair for recharging purposes.

Preferably, the lighting system is designed so that, when it is attached to the underside of the armrest, it will not project beyond the outside edge of the armrest, and, ideally, the lighting system will not be any wider than armrest. Such a configuration will allow a user to easily operate the wheelchair and to negotiate tight spaces without interference from either lighting system and without occasioning impacts to the light that might otherwise cause untimely removal or detachment of the light from the mounting component beneath the armrest, to the inconvenience of the user. In addition, such configuration permits the wheelchair, even with the flashlight mounted thereto, to be folded flat without any necessity of removing the lighting systems from their respective armrests.

The simplicity of the preferred lighting system embodiment, with a metal plate under each armrest and a battery powered light system with an integrated permanent magnet on each light system, makes for a very facile, simple, easy to use, and versatile wheelchair lighting system.

It should be appreciated that, although it is envisioned that the invention will typically be applied to pre-existing wheelchairs so as to accommodate a lighting system to facilitate illumination forwardly and/or rearwardly of the wheelchair during its usage, the invention can also be readily incorporated into wheelchairs as they are manufactured and sold. In the latter events, a mounting component such as described and discussed above can be readily secured to a wheelchair armrest during manufacture, and a user can thereafter conveniently engage a portable light, such as a flashlight, with such mounting component, in the same or like manners as already described and discussed. Especially in such event, the mounting component, such as a metallized strip, may, during wheelchair manufacture, be secured to the armrest, especially the underside of the armrest, by any suitable constructions or processes, including screws and bolts to mention but a few possible approaches, so as to effect a secure attachment of the mounting component to the armrest for the practice of the invention. In accordance with previous discussions herein, such a metallized strip would preferably be dimensioned to generally conform to the underside of the armrest and fit within the lateral dimensions of the armrest.

This lighting system will use, generally, two AAA type batteries. This allows for the overall width of the lighting system to be a one inch maximum width. This width keeps the light system from protruding beyond the side of the armrest, during usage. As stated, it does not become an obstruction for the person negotiating the wheelchair.

Variations or modifications to the subject matter of this invention may occur to those skilled in the art upon reviewing the invention as described herein. Such variations, if within the spirit of this invention, are intended to be encompassed within the scope of any claims to patent protection issuing herein or herefrom. The specific depictions of the invention, as described in the specification, and as illustrated in the drawings, are set forth as exemplary embodiments, and are not intended to encompass all possible embodiments.

We claim:

1. A wheelchair lighting assembly including at least one armrest for a wheelchair, supported by a wheelchair support, and having an undersurface for the armrest for accommodating the application of a cut segment of double sided tape, a metallized strip corresponding generally to the dimensions of the double sided tape, adhering to the underside of the double sided tape, and said metallized strip capable of securing with a magnet of a flashlight that may be releasably secured thereto, during application and usage.

2. The wheelchair lighting assembly of claim 1 wherein said flashlight may be directed for illumination forwardly, and reversed for directing illumination rearwardly, or the flashlight may be removed from its magnetic adherence to the metal strip to provide a portable flashlight for directing its light and illumination in various other directions.

3. A kit for providing a removable light for a wheelchair that includes at least one armrest extending along a side of the wheelchair, comprising:
a mounting component securable to the armrest of the wheelchair; and
said mounting component being complementarily engageable with the light to removably attach the light to said mounting component while said mounting component is secured to the armrest of the wheelchair.

4. The kit of claim 3 wherein the armrest of the wheelchair has an underside and said kit also includes a piece of double sided tape, one side of which tape is positionable upon the underside of the armrest of the wheelchair to attach said piece of tape to the armrest, said mounting component attachable to the other side of said double sided tape to secure said mounting component to said tape attached to the armrest.

5. The kit of claim 3 further including:
a self-powered lighting element having an elongated side surface; and
said side surface of said lighting element and said mounting component being complementarily engageable with one another to removably attach said lighting element to said mounting component while said mounting component is secured to the armrest of the wheelchair.

6. The kit of claim 5 wherein said mounting component and said side surface of the lighting element are magnetically coupleable to one another to removably attach said lighting element to said mounting component.

7. The kit of claim 6 wherein said mounting component includes a metallic strip and said side surface of said lighting element includes a magnetic portion, said metallic strip of said mounting component and said magnetic portion of said lighting element being positionable adjacent one another to magnetically bind said lighting element to said mounting component.

8. The kit of claim 7 wherein said lighting element includes a flashlight having a magnet secured thereto on one side of the flashlight to form said magnetic portion.

9. The kit of claim 6 wherein said mounting component includes a magnetized portion to which an additional user accessory element can be magnetically attached when said mounting component is secured to the wheelchair.

10. The kit of claim 5 wherein said lighting element is readily attachable and detachable from said mounting component by a user without the necessity of mounting or removal tools.

11. The kit of claim 5 wherein the wheelchair is electrically powered and said lighting element, when secured to the armrest of the wheelchair, is connectable to the electrical power of the wheelchair to derive power therefrom.

12. A method of removably attaching a light to a wheelchair that includes at least one armrest extending along a side of the wheelchair, comprising:
providing a self-powered lighting element having an elongated side surface;
providing a mounting component securable to the armrest of the wheelchair;
said side surface of said lighting element and said mounting component being complementarily engageable with one another to removably attach said lighting element to said mounting component while said mounting component is secured to the armrest of the wheelchair;
securing said mounting component to the armrest of the wheelchair; and
attaching said lighting element to said mounting component.

13. The method of claim 12 wherein the armrest of the wheelchair includes an underside and the step of securing said mounting component to the armrest of the wheelchair includes:
providing a piece of double sided tape, one side of which is positionable upon the underside of the armrest of the wheelchair to attach said piece of tape to the armrest, said mounting component attachable to the other side of said double sided tape to secure said mounting component to the armrest;
positioning one side of said double sided tape upon the underside of the armrest of the wheelchair and attaching said piece of tape to the armrest; and
attaching said mounting component to the other side of said double sided tape.

14. The method of claim 11 wherein:
said mounting component includes a metallic strip;
said side surface of said lighting element includes a magnetic portion;
said metallic strip of said mounting component and said magnetic portion of said lighting element are magnetically coupleable to one another when positioned adjacent to one another; and
further wherein the step of attaching said lighting element to said mounting component includes positioning said metallic strip of said mounting component adjacent said magnetic portion of said lighting element to magnetically bind said lighting element to said mounting component.

15. A wheelchair improvement, for a wheelchair having at least one armrest extending along a side of the wheelchair, for facilitating the attachment of a removable light to the wheelchair, comprising:
a mounting component secured to the armrest; and
said mounting component being complementarily engageable with the light to removably attach the light to said secured mounting component.

16. The wheelchair improvement of claim 15 wherein:
the armrest of the wheelchair has an underside;
the removable light is a flashlight;
said mounting component includes a metallized strip;
said metallized strip is dimensioned to generally conform to the underside of the armrest and fit within the lateral dimensions of the armrest; and
said metallized strip and the flashlight are magnetically coupleable to one another to removably attach the flashlight to said metallized strip.

17. The wheelchair improvement of claim 15, wherein said armrest attachment and its removable light are provided for indoor usage.
